(19) United States
(12) Patent Application Publication
(10) Pub. No.: US 2009/0135254 A1
(43) Pub. Date: May 28, 2009

(54) IMAGE CAPTURING DEVICE AND METHOD FOR TRACKING OBJECT OF SAME

(75) Inventor: YI-TA CHIANG-LIN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/134,226

(22) Filed: Jun. 6, 2008

(30) Foreign Application Priority Data
Nov. 27, 2007 (CN) 200710202728.2

(51) Int. Cl. H04N 5/225

(52) U.S. Cl. 348/169; 348/E05.024

(57) ABSTRACT

An image capturing device includes a main body with an image capturing unit received therein, a base, a pan and tilt mechanism for rotating the main body relative to the base, a viewfinder display window, and an object tracking system. The object tracking system includes an object obtaining unit, a storing unit, a detecting unit, a calculating unit, and a driving unit. The object obtaining unit is used for selecting and obtaining an object for tracking in the viewfinder display window. The storing unit is used for storing the information of the object. The detecting unit is used for detecting the position of the object image displayed in the viewfinder display window. The calculating unit is used for calculating an amount and direction of rotation for the main body. The driving unit is used for driving the pan and tilt mechanism to rotate the main body.

### TECHNICAL FIELD

The present invention relates to image capturing devices and, particularly, to an image capturing device which can automatically pan and tilt to track a moving object.

### DESCRIPTION OF RELATED ART

With the development of optical imaging technology, image capturing devices are widely used now. People uses image capturing devices to take not only pictures of stationary objects, but also but also pictures of moving objects.

Most image capturing devices cannot follow an object in motion, and must be directed by a user to do so. The problem is that users may have difficulty tracking a moving object accurately to capture an image with desired quality.

What is needed, therefore, is an image capturing device which can automatically track a moving object.

### SUMMARY

In accordance with one present embodiment, an image capturing device includes a main body, a base, a pan and tilt mechanism, a viewfinder display window, and an object tracking system. The main body has an image capturing unit received therein, the image capturing unit includes a lens module and an image sensor for converting an optical object image into an electronic image signal. The pan and tilt mechanism connects the main body to the base and is for rotating the main body relative to the base. The viewfinder display window is connected to the image sensor of the image capturing unit for displaying the image sensed by the image sensor. The object tracking system includes an object obtaining unit, a storing unit, a detecting unit, a calculating unit, and a driving unit. The object obtaining unit is used for selecting and obtaining an object for tracking in the viewfinder display window. The storing unit is used for storing the information of the object obtained by the object obtaining unit. The detecting unit is used for detecting the position of the object image displayed in the viewfinder display window at proper intervals. The calculating unit is used for calculating an amount and direction of movement of the main body by the pan and tilt mechanism corresponding to the position of the obtained object as determined by the position of the image of the object in the viewfinder display window. The driving unit is used for driving the pan and tilt mechanism to move the main body by the calculated amount and to the calculated direction.

### BRIEF DESCRIPTION OF THE DRAWINGS

Many aspects of the present image capturing device can be better understood with reference to the accompanying drawings. The components in the drawings are not necessarily drawn to scale, the emphasis instead being placed upon clearly illustrating the principles of the present image capturing device. Moreover, in the drawings, like reference numerals designate corresponding parts throughout the several views.

FIG. 1 is a schematic view of an image capturing device according to a present embodiment.

FIG. 2 is a schematic, functional block diagram of the image capturing device of FIG. 1.

FIG. 3 is a flow chart of a method for tracking an object of the image capturing device of FIG. 1.

### DETAILED DESCRIPTION OF THE EMBODIMENTS

Exemplary embodiments will now be described in detail below, with reference to the drawings.

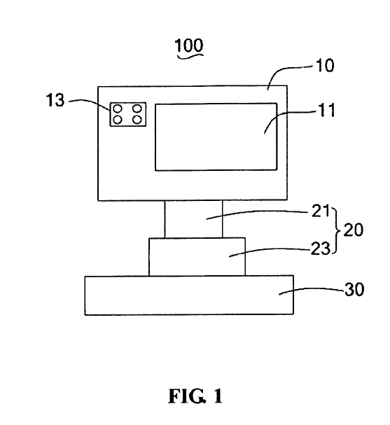

Referring to FIG. 1, an image capturing device 100 according to an embodiment is shown. The image capturing device 100 includes a main body 10, a pan and tilt mechanism 20, and a base 30. The main body 10 and the base 30 are connected to opposite ends of the pan and tilt mechanism 20 respectively. The image capturing device 100 can be a hand-held camera.

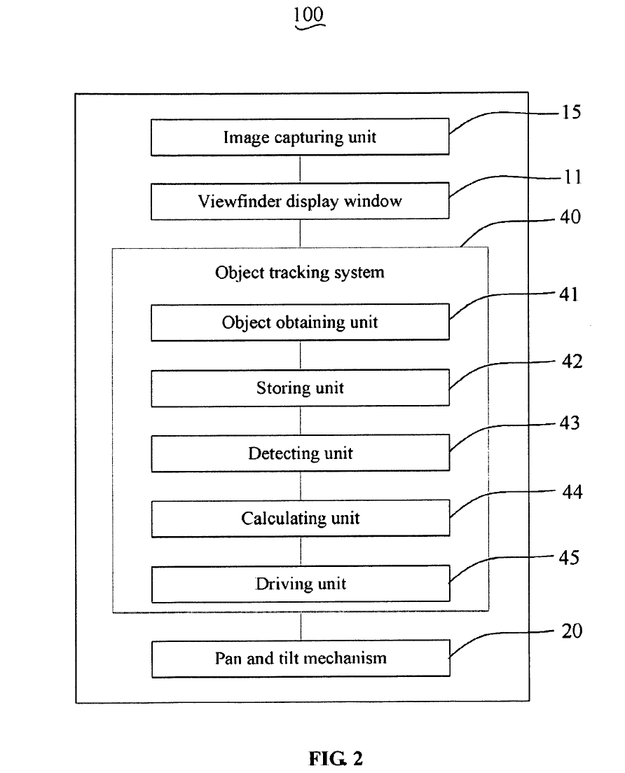

In the present embodiment, the main body 10 has a viewfinder display window 11, a number of operational buttons 13, and an image capturing unit 15 shown in FIG. 2.

The image capturing unit 15 includes a lens module (not shown) and an image sensor disposed behind the lens module for converting an optical object image into an electronic image signal.

The viewfinder display window 11 is electrically connected with the image sensor of the image capturing unit 15 for displaying the object image sensed by the image sensor. In the present embodiment, the viewfinder display window 11 is a touch screen.

By manipulating the operational buttons 13, it is possible to turn on and off a power supply of the image capturing device 100, further, it is also possible to switch between a picture taking mode and a playback mode. In addition, a captured image can be saved or deleted as desired with the operational buttons 13. Furthermore, by manipulating the operational buttons 13, it is possible to optionally select an object displayed in the viewfinder display window 11.

The pan and tilt mechanism 20 is configured for rotating the main body 10 in order to follow a moving object. In the present embodiment, the pan and tilt mechanism 20 includes a vertically rotating mechanism 21 and a horizontal rotating mechanism 23. The vertically rotating mechanism 21 can rotate in a plane perpendicular to the base 30 and the horizontal rotating mechanism 23 can rotate parallel to the base 30.

It is understood that only the image capturing unit 15 of the image capturing device 100 is needed to be received in the main body 10 in order to track an object, the viewfinder display window 11 and the operational buttons 13 can alternatively be disposed on the base 30 instead of disposed on the main body 10.

FIG. 2 shows a block diagram of the image capturing device 100, the image capturing device 100 further includes an object tracking system 40. The object tracking system 40 includes an object obtaining unit 41, a storing unit 42, a detecting unit 43, a calculating unit 44, and a driving unit 45.

The object obtaining unit 41 is used for obtaining a selected object which will be tracked by the image capturing device 100 in the viewfinder display window 11. In the present embodiment, the object can be selected by an input device such as the operational buttons 13 or the touch screen of the viewfinder display window 11. In the present embodiment, we use the touch screen to select an area on the viewfinder display window 11 surrounding the object, then, the edge of the object can be identified and obtained by the object obtaining unit 41.

The storing unit 42 is used for storing the information of the object obtained by the object obtaining unit 41. The information can be a shape of the object or a shape of a component of the object. For example, if the obtained object is a car, the information stored in the storing unit 42 can correspond to a shape of the car or a shape of a window of the car.

The detecting unit 43 is used for detecting the position of the object image displayed in the viewfinder display window 11 at proper intervals, for instance every second, by using the information of the object stored in the storing unit 42.

The calculating unit 44 is used for calculating an amount and direction of movement of the main body 10 by the pan and tilt mechanism 20 corresponding to the position of the obtained object as determined by position of the image of the object in the viewfinder display window 11, so that the main body 10 can follow the moving object and keep it displayed around the center of the viewfinder display window 11.

The driving unit 45 is used for driving the pan and tilt mechanism 20 to move the main body 10 by the calculated amount and in the calculated direction.

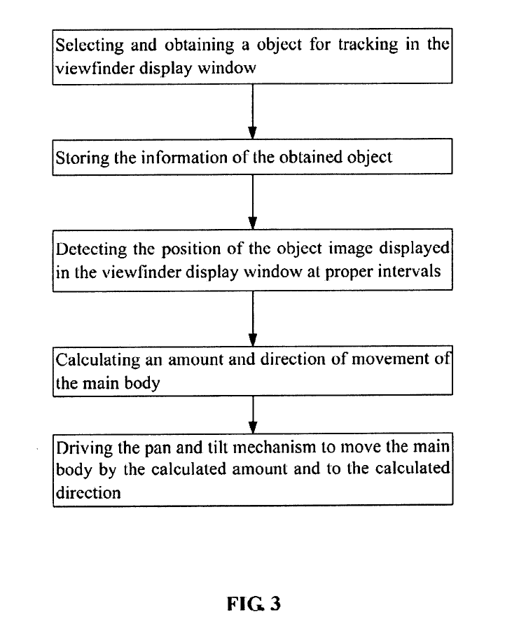

Referring to FIG. 3, a method for tracking an object of the image capturing device 100 is also provided. The method includes the steps of: selecting and obtaining an object for tracking in the viewfinder display window 11; storing the information of the obtained object; detecting the position of the object image displayed in the viewfinder display window 11 at proper intervals; calculating an amount and direction of rotation for the main body 10 by the pan and tilt mechanism 20 corresponding to the position of the obtained object as determined by position of the image of the object in the viewfinder display window 11; driving the pan and tilt mechanism 20 to rotate the main body 10 by the calculated amount to the calculated direction.

The step of selecting an object can be performed by an input device such as the operational buttons 13 or the touch screen of the viewfinder display window 11. The information of the object can be a shape of the object or a shape of a component of the object.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. An image capturing device comprising:
a main body with an image capturing unit received therein, the image capturing unit comprising a lens module and an image sensor disposed behind the lens module for converting an optical object image into an electronic image signal;
a base;
a pan and tilt mechanism connecting the main body to the base and capable of rotating the main body relative to the base;
a viewfinder display window electrically connected to the image sensor of the image capturing unit for displaying the object image sensed by the image sensor, the viewfinder display window having a touch screen for selecting an object for tracking in the viewfinder display window; and
an object tracking system comprising:
an object obtaining unit for obtaining a selected object;
a storing unit for storing the information of the object obtained by the object obtaining unit;
a detecting unit for detecting the position of the object image displayed in the viewfinder display window at proper intervals;
a calculating unit for calculating an amount and direction of movement of the main body by the pan and tilt mechanism corresponding to the position of the obtained object as determined by the position of the image of the object in the viewfinder display window; and
a driving unit for driving the pan and tilt mechanism to move the main body by the calculated amount and to the calculated direction.

2. The image capturing device as claimed in claim 1, wherein the image capturing device is a hand-held camera.

3. The image capturing device as claimed in claim 1, wherein the viewfinder display window is disposed on the main body.

4. The image capturing device as claimed in claim 1, wherein the viewfinder display window is disposed on the base.

5. The image capturing device as claimed in claim 1, wherein the image capturing device comprises a number of operational buttons capable of being used for selecting an object for tracking in the viewfinder display window.

6. The image capturing device as claimed in claim 5, wherein the operational buttons are either disposed on the main body or on the base.

7. The image capturing device as claimed in claim 1, wherein the pan and tilt mechanism comprises a vertically rotating mechanism capable of rotating along a plane perpendicular the base and a horizontal rotating mechanism capable of rotating parallel to the base.

8. The image capturing device as claimed in claim 1, wherein the information of the object is selected from the group consisting of a shape of the object and a shape of a component of the object.

9. A method for tracking an object of the image capturing device, the image capturing device comprising a main body with an image capturing unit received therein, a base, a pan and tilt mechanism connecting the main body and the base for rotating the main body relative to the base, and a viewfinder display window with a touch screen for selecting an object for tracking, comprising:
selecting and obtaining an object for tracking in the viewfinder display window; storing the information of the obtained object;
detecting the position of the object image displayed in the viewfinder display window at proper intervals;
calculating an amount and direction of movement of the main body by the pan and tilt mechanism corresponding to the position of the obtained object as determined by the position of the image of the object in the viewfinder display window; and
driving the pan and tilt mechanism to move the main body by the calculated amount and to the calculated direction.

10. The method as claimed in claim 9, wherein the viewfinder display window comprises a touch screen and the object is selected by using a touch screen.

11. The method as claimed in claim 9, wherein the information of the object is selected from the group consisting of a shape of the object and a shape of a component of the object.
